(19) United States
(12) Patent Application Publication
(10) Pub. No.: US 2026/0259106 A1
(43) Pub. Date: Sep. 3, 2026

(54) OPTICAL FIBER GROUP DELAY CHARACTERISTICS TEST EQUIPMENT AND METHODS

(71) Applicant: NTT, Inc., Tokyo (JP)

(72) Inventors: Masaki NAKAMORI, Musashino-shi, Tokyo (JP); Atsushi NAKAMURA, Musashino-shi, Tokyo (JP); Yusuke KOSHIKIYA, Musashino-shi, Tokyo (JP)

(73) Assignee: NTT, Inc., Tokyo (JP)

(21) Appl. No.: 19/158,385

(22) PCT Filed: Feb. 24, 2023
(86) PCT No.: PCT/JP2023/006740

§ 371 Date: Aug. 20, 2025

(51) Int. Cl. G01M 11/00; G01M 11/02

(52) U.S. Cl. CPC G01M 11/3127; G01M 11/02; G01M 11/3118; G01M 11/3145

(57) ABSTRACT

The present disclosure is an optical fiber group delay characteristic test device characterized by comprising: an optical pulse tester that outputs an optical pulse toward an optical fiber under test and measures a reflected optical pulse arriving from the optical fiber under test; an optical multiplexer/demultiplexer that demultiplexes the optical pulse from the optical pulse tester into a plurality of optical pulses and multiplexes reflected optical pulses in a plurality of propagation modes arriving from the optical fiber under test, thereby outputting the multiplexed optical pulse to the optical pulse tester; a delay adder that adds delay amounts different from one another to the plurality of optical pulses from the optical multiplexer/demultiplexer and adds delay amounts different from one another to the reflected optical pulses in the plurality of propagation modes arriving from the optical fiber under test; a mode multiplexer/demultiplexer that multiplexes the plurality of optical pulses from the delay adder, thereby inputting the pulses to the optical fiber under test such that the pulses are different in propagation mode and demultiplexes the reflected optical pulses from the optical fiber under test into the pulse in each of the propagation modes, thereby outputting the pulse in each propagation mode to the delay adder; and a computation processing unit that measures a delay time in each propagation mode from the input of the optical pulses from the optical pulse tester to the optical fiber under test until output of the reflected optical pulses from the optical fiber under test and calculates a group delay characteristic on the basis of the measured delay time in each propagation mode.

### TECHNICAL FIELD

The present disclosure relates to a testing device and a testing method for measuring group delay characteristics of a few mode fiber (FMF).

### BACKGROUND ART

In order to enlarge a transmission capacity per optical fiber, research and development of space division multiplexing (SDM) transmission has been extensively performed. As a means for increasing the transmission capacity per optical fiber, an FMF has been attracting attention. In the FMF, group delay characteristics such as a group delay for each propagation mode, a group delay difference between modes, a wavelength dispersion for each propagation mode, and the like are important parameters for constructing a transmission line. For this reason, evaluation of these group delay characteristics has been necessary for the practical use of the spatial multiplex transmission using an FMF.

Measurement of a group delay in FMF with an optical time domain reflectometry (OTDR) has been reported (see, e.g., NPL 1). In this report, each propagation mode is separated by using a photonic lantern for the FMF by using a photonic lanthanum, and the group delay is measured by a correlation OTDR.

### CITATION LIST

### Non Patent Literature

[NPL 1] Linqi Jin, Yong Wang, Meiling Zhang, Yadong Sun, and Guijun Hu, “Measurement of differential mode group delay in few-mode fiber with correlation optical time-domain reflectometer,” Appl. Opt. vol. 61, no. 13, pp. 3579-3582, (2022).

### SUMMARY OF INVENTION

### Technical Problem

The method of NPL 1 requires operations of measuring group delay times for all modes separately. That is, when there are a plurality of propagation modes, measurement need to be repeated independently for each mode, which takes a long time. In addition, expensive modulators and receivers are required.

Therefore, an object of the present disclosure is to provide an efficient and economical optical fiber group delay characteristic testing device and optical fiber group delay characteristic testing method for FMF.

### Solution to Problem

In order to achieve the above object, in the optical fiber group delay characteristic testing device and the optical fiber group delay characteristic testing method according to the present disclosure, group delay characteristics are calculated on the basis of a delay time for each propagation mode with regard to a period from a time when optical pulses of different propagation modes are input to the test target optical fiber to a time when reflected optical pulses are output from the test target optical fiber. In this regard, different delay amounts are imparted to propagation modes separately.

Specifically, the present disclosure provides an optical fiber group delay characteristic testing device including: an optical pulse tester which outputs an optical pulse toward a test target optical fiber, and measures reflected optical pulses coming from the test target optical fiber;
an optical multiplexer/demultiplexer which demultiplexes the optical pulse from the optical pulse tester into a plurality of optical pulses, multiplexes the plurality of reflected optical pulses coming from the test target optical fiber, and outputs the reflected optical pulses to the optical pulse tester;
a delay applier which imparts different delay amounts to a plurality of optical pulses from the optical multiplexer/demultiplexer separately, and imparts different delay amounts to reflected optical pulses of a plurality of propagation modes coming from the test target optical fiber; a mode multiplexer/demultiplexer which multiplexes the plurality of optical pulses from the delay applier, inputs the plurality of optical pulses into the test target optical fiber so that the plurality of optical pulses have different propagation modes separately, demultiplexes the reflected optical pulses of the different propagation modes from the test target optical fiber, for each propagation mode, and outputs the reflected optical pulses to the delay applier separately; and
an arithmetic processing unit which measures a delay time for each propagation mode with regard to a period from a time when the optical pulses, originating from the optical pulse tester, are input to the test target optical fiber to a time when the reflected optical pulses are output from the test target optical fiber, and calculates group delay characteristics based on the measured delay time for each propagation mode.

The present disclosure is also characterized in that the arithmetic processing unit corrects a delay time for each propagation mode, with regard to a period from a time when the optical pulse is output from the optical pulse tester to a time when the reflected optical pulses are measured thereby, by the delay amounts for the respective propagation modes imparted by the delay applier, and calculates a group delay for each propagation mode.

The present disclosure is also characterized in that the arithmetic processing unit calculates a group delay time difference between propagation modes from the group delay of each of the propagation modes.

The present disclosure is also characterized in that the optical pulse tester outputs optical pulses, using three or more different wavelengths, toward the test target optical fiber, and measures reflected optical pulses from the test target optical fiber, and
the arithmetic processing unit calculates a group delay of each wavelength for each propagation mode, and calculates a wavelength dispersion for each propagation mode.

The present disclosure is also characterized in that any delay amount imparted by the delay applier is not a half of a sum of any two other delay amounts.

The present disclosure is also characterized in that any delay amount imparted by the delay applier is not half of any other delay amount.

Specifically, the present disclosure provides an optical fiber group delay characteristic testing method including:
measuring a delay time for each propagation mode, with regard to a period from a time when a plurality of optical pulses are input into a test target optical fiber so that the optical pulses have different propagation modes to a time when reflected optical pulses of different propagation modes are output from the test target optical fiber, by imparting different delay amounts to propagation modes separately; and correcting the measured delay time for each propagation mode by the delay amounts for the respective propagation modes, and calculating group delay characteristics for each propagation mode.

The present disclosure is also characterized in that any imparted delay amount is larger than a maximum value of a group delay time difference between any propagation modes in the test target optical fiber.

The above disclosures can be combined as much as possible.

### Advantageous Effects of Invention

The present disclosure can provide an efficient and economical optical fiber group delay characteristic testing device and optical fiber group delay characteristic testing method for FMF.

### BRIEF DESCRIPTION OF DRAWINGS

FIG. 1 is a diagram explaining a configuration of an optical fiber group delay characteristic testing device disclosed herein.

FIG. 2 is a diagram explaining a delay applier of the optical fiber group delay characteristic testing device disclosed herein.

FIG. 3 is a diagram for explaining time response waveforms at times when reflected optical pulses are received.

FIG. 4 is a diagram explaining a method for calculating a group delay time difference.

FIG. 5 is a schematic diagram of response waveforms of reflected optical pulses.

FIG. 6 is a diagram explaining propagation paths of an optical pulse and a reflected optical pulse.

FIG. 7 is a schematic diagram of response waveforms of reflected optical pulses.

FIG. 8 is a diagram explaining propagation paths of an optical pulse and a reflected optical pulse.

FIG. 9 is a schematic diagram of response waveforms of reflected optical pulses.

### DESCRIPTION OF EMBODIMENTS

Embodiments of the present disclosure will be described hereinafter in detail with reference to the drawings. It is to be understood that the present disclosure is not limited to the embodiments described below. The embodiments are merely exemplary and the present disclosure can be implemented in various modified and improved modes based on knowledge of those skilled in the art. Structural elements indicated by the same reference sign in the present specification and in the drawings are the same.

In an optical fiber group delay characteristic testing device and an optical fiber group delay characteristic testing method according to the present disclosure, group delay characteristics are calculated on the basis of a delay time for each propagation mode, with regard to a period from a time when a plurality of optical pulses are input to an test target optical fiber so that the optical pulses have different propagation modes to a time when reflected optical pulses of different propagation modes are output from the test target optical fiber. In this regard, different delay amounts are imparted to propagation modes separately. The delay amounts may be imparted before the optical pulses are input to the test target optical fiber, or may be imparted after the reflected optical pulses are output from the test target optical fiber, or may be both.

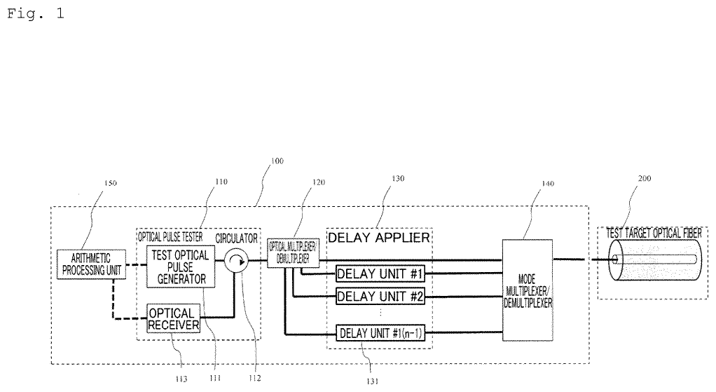

A configuration of an optical fiber group delay characteristic testing device 100 according to the present embodiment is illustrated in FIG. 1. An optical fiber group delay characteristic testing device 100 illustrated in FIG. 1 includes: an optical pulse tester 110 which outputs an optical pulse toward an test target optical fiber 200, and measures reflected optical pulses coming from the test target optical fiber 200; an optical multiplexer/demultiplexer 120 which demultiplexes the optical pulse from the optical pulse tester 110 into a plurality of optical pulses, multiplexes the reflected optical pulses of a plurality of propagation modes coming from the test target optical fiber 200, and outputs the reflected optical pulses to the optical pulse tester 110; a delay applier 130 which imparts different delay amounts to a plurality of optical pulses from the optical multiplexer/demultiplexer 120 separately, and imparts different delay amounts to reflected optical pulses of a plurality of propagation modes coming from the test target optical fiber; a mode multiplexer/demultiplexer 140 which multiplexes the plurality of optical pulses from the delay applier 130, inputs the plurality of optical pulses into the test target optical fiber 200 so that the plurality of optical pulses have different propagation modes separately, demultiplexes the reflected optical pulses of the different propagation modes from the test target optical fiber 200, for each propagation mode, and outputs the reflected optical pulses to the delay applier 130 separately; and an arithmetic processing unit 150 which measures a delay time for each propagation mode with regard to a period from a time when the optical pulses, originating from the optical pulse tester 110, are input to the test target optical fiber 200 to a time when the reflected optical pulses are output from the test target optical fiber 200, and calculates group delay characteristics based on the measured delay time for each propagation mode.

The optical fiber group delay characteristic testing method of the present embodiment includes: measuring a delay time for each propagation mode, with regard to a period from a time when a plurality of optical pulses are input into a test target optical fiber 200 so that the plurality of optical pulses have different propagation modes to a time when reflected optical pulses of different propagation modes are output from the test target optical fiber 200, by imparting different delay amounts to propagation modes separately; and correcting the measured delay time for each propagation mode by the delay amounts for the respective propagation modes, and calculating group delay characteristics for each propagation mode.

The optical pulse tester 110 includes a test optical pulse generator 111, a circulator 112, and an optical receiver 113. The test optical pulse generator 111 outputs a testing optical pulse. The circulator 112 outputs the optical pulse from the test optical pulse generator 111 to the optical multiplexer/demultiplexer 120, and outputs the reflected optical pulses from the optical multiplexer/demultiplexer 120 to the optical receiver 113. The optical receiver 113 receives the reflected light pulses from the circulator 112 and converts them into electrical signals.

The optical multiplexer/demultiplexer 120 divides the optical pulse from the circulator 112 into a plurality of pulses, and outputs the plurality of pulses to the delay applier 130. Further, the plurality of reflected optical pulses from the delay applier 130 are multiplexed and output to the circulator 112.

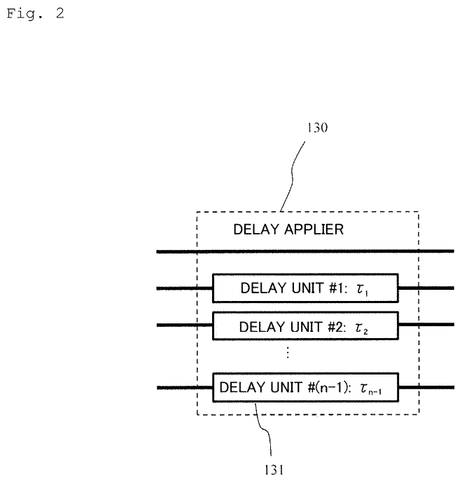

The delay applier 130 is provided with (n−1) delay units 131 (n is a positive integer) distributed into delay units #1 to #(n−1). A delay amount of a path having no delay unit may be deemed to be zero. Provided that no paths having delay amounts that are zero are included, n delay units may be deemed to be substantial. A configuration of the delay applier 130 is shown in FIG. 2. The delay unit 131 imparts different delay amounts τ₁, τ₂, τₙ₋₁ to the plurality of optical pulses, from the optical multiplexer/demultiplexer 120, separately. Further, the delay unit 131 imparts the different delay amounts τ₁, τ₂, . . . τₙ₋₁ to the plurality of reflected optical pulses, from the mode multiplexer/demultiplexer 140, separately. The delay amount of the path having no delay unit may be deemed to be zero.

The mode multiplexer/demultiplexer 140 multiplexes the plurality of optical pulses from the delay applier 130 and inputs them to the test target optical fiber 200 so that they have the different propagation modes separately. The mode multiplexer/demultiplexer 140 demultiplexes the reflected optical pulses of the different propagation modes from the test target optical fiber 200, for each propagation mode, and outputs to the delay applier 130 separately.

The arithmetic processing unit 150 measures a delay time for each propagation mode with regard to the period from the time when the optical pulses, originating from the optical fiber group delay characteristic testing device 100, are input to the test target optical fiber 200 to the time when the reflected optical pulse are output from the test target optical fiber 200. The delay amounts imparted by the delay applier 130 are different for the respective propagation modes corresponding thereto; although the test optical pulse generator 111 outputs one optical pulse, the optical receiver 113 can receive the reflected optical pulses of the respective propagation modes, at different times, separately. As a result, the arithmetic processing unit 150 can measure the delay time for each propagation mode one by one. The arithmetic processing unit 150 corrects the delay time for each propagation mode with different delay amounts for the respective propagation modes imparted by the delay applier 130, and calculates group delay characteristics. Further, after the internal delay amounts of the optical pulse tester 110, the optical multiplexer/demultiplexer 120 and the like in the optical fiber group delay characteristic testing device 100 are measured in advance, the arithmetic processing unit 150 preferably calibrates the measured delay time with the internal delay amounts.

The arithmetic processing unit 150 of the present disclosure can also be realized by a computer and a program, and the program can be recorded on a recording medium or provided through a network.

In the optical fiber group delay characteristic testing device, although reciprocating time of the optical pulse in the test target optical fiber 200 is actually measured, it may be converted into a one-way time to be converted into the delay time.

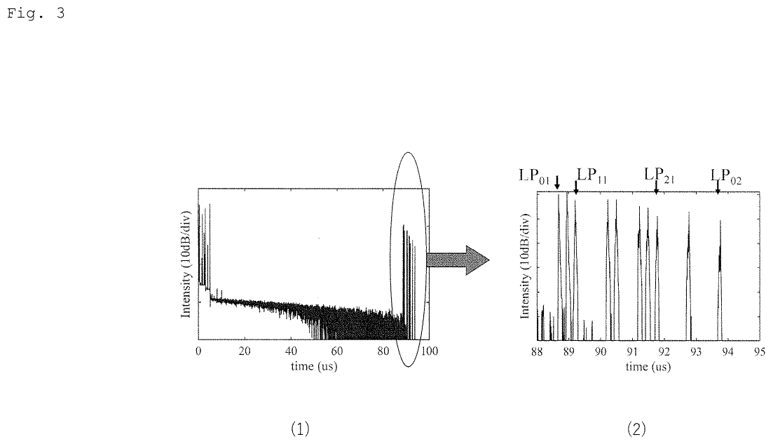

FIG. 3 shows time response waveforms at times when the reflected optical pulses are received by the optical pulse tester 110. FIG. 3(1) illustrates the response waveforms, from the time 0 to 100 μs, with respect to four LP mode optical fibers having LP₀₁, LP₁₁, LP₂₁, and LP₀₂, and FIG. 3(2) is an enlarged view of FIG. 3(1) from 88 to 95 μs. From the response waveforms illustrated in FIG. 3, a group delay is calculated with regard to optical pulses that advance from an input end to a far end of the test target optical fiber 200. As a method for calculating the group delay, for example, there are a method for getting a response waveform, in a vicinity of a peak of light intensity of a reflected optical pulse generated by far end reflection, approximating a quadratic function to calculate a time at an apex thereof, and a method for calculating a time by calculating the first-order moment regarding a time of the response waveform in the vicinity of the peak.

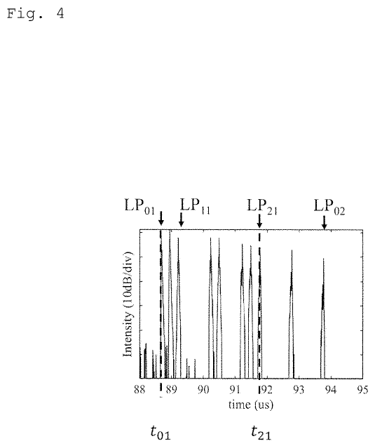

A method for calculating a group delay time difference is explained in FIG. 4. The arithmetic processing unit 150 calculates a group delay difference between propagation modes from the group delay of each propagation mode. For example, given that a group delay of a basic mode pertaining to an LP₀₁ mode and a group delay pertaining to an LPᵢⱼ mode at a wavelength λ are defined as τ₀₁(λ) and τᵢⱼ(λ), a group delay time difference Δτ(λ) between the LP₀₁ mode and the LPᵢⱼ mode is expressed by the following equation.

$$Δ τ ( λ ) = {τ}_{ij} ( λ ) - {τ}_{01} ( λ ) \qquad [ Math . 1 ]$$

The group delay τᵢⱼ(λ) at the wavelength λ is calculated by the following equation.

$${τ}_{ij} ( λ ) = {t}_{ij} - {τ}_{ij\_delay} ( λ ) \qquad [ Math . 2 ]$$

tᵢⱼ: Delay time of a response waveform in the LPᵢⱼ mode
Tᵢⱼ_delay(λ): Delay amount for correction to the LPᵢⱼ mode

$${τ}_{01} ( λ ) = {t}_{01} - {τ}_{01 \_delay} ( λ ) \qquad [ Math . 3 ]$$

t₀₁: Delay time of a response waveform in the LP₀₁ mode
τ₀₁_delay(λ): Delay amount for correction to the LP₀₁ mode

FIG. 4 illustrates examples of the delay time t₀₁ of the LP₀₁ mode and a delay time t₂₁ of the LP₂₁ mode. The group delay time difference may be standardized by a length of the test target optical fiber 200, and thereby be a calculated the group delay time difference per unit length Δτ(s/m).

A method for calculating wavelength dispersion for each propagation mode using three or more different wavelengths will be described. The optical fiber group delay characteristic testing device 100 outputs each optical pulse toward the test target optical fiber 200, as mentioned above, using three or more different wavelengths, and measures a delay time for each propagation mode with regard to a period before receiving reflected optical pulses from the test target optical fiber 200. Each group delay is calculated from the measured delay time, and wavelength dispersion for each propagation mode is calculated.

Here, an example of three wavelengths is shown. When the measurement is performed at three or more wavelengths, measurement results at three wavelengths freely-selected therefrom are used. By fitting group delays τ(λ₁), τ(λ₂), and τ(λ₃) of three wavelengths λ₁, λ₂, and λ₃ by an approximate expression of the group delays, i.e. the following equation, coefficients a, b and c are determined.

$$\begin{matrix}[ Math . 4 ] & \\ a = \vert \begin{matrix}τ ( {λ}_{1} ) & {λ}_{1}^{2} & {λ}_{1}^{- 2} \\ τ ( {λ}_{2} ) & {λ}_{2}^{2} & {λ}_{2}^{- 2} \\ τ ( {λ}_{3} ) & {λ}_{3}^{2} & {λ}_{3}^{- 2}\end{matrix} \vert / \vert \begin{matrix}1 & {λ}_{1}^{2} & {λ}_{1}^{- 2} \\ 1 & {λ}_{2}^{2} & {λ}_{2}^{- 2} \\ 1 & {λ}_{3}^{2} & {λ}_{3}^{- 2}\end{matrix} \vert = \frac{\begin{matrix}τ ( {λ}_{1} ) ( {λ}_{2}^{2} {λ}_{3}^{- 2} - {λ}_{3}^{2} {λ}_{2}^{- 2} ) + \\ τ ( {λ}_{2} ) ( {λ}_{3}^{2} {λ}_{3}^{- 2} - {λ}_{1}^{2} {λ}_{3}^{- 2} ) + τ ( {λ}_{3} ) ( {λ}_{1}^{2} {λ}_{2}^{- 2} - {λ}_{2}^{2} {λ}_{1}^{- 1} )\end{matrix}}{{λ}_{1}^{2} ( {λ}_{2}^{- 2} - {λ}_{3}^{- 2} ) + {λ}_{2}^{2} ( {λ}_{3}^{- 2} - {λ}_{1}^{- 2} ) + {λ}_{3}^{2} ( {λ}_{1}^{- 2} - {λ}_{2}^{- 2} )} & ( 4 )\end{matrix}$$

$$b = \vert \begin{matrix}1 & τ ( {λ}_{1} ) & {λ}_{1}^{- 2} \\ 1 & τ ( {λ}_{2} ) & {λ}_{2}^{- 2} \\ 1 & τ ( {λ}_{3} ) & {λ}_{3}^{- 2}\end{matrix} \vert / \vert \begin{matrix}1 & {λ}_{1}^{2} & {λ}_{1}^{- 2} \\ 1 & {λ}_{2}^{2} & {λ}_{2}^{- 2} \\ 1 & {λ}_{3}^{2} & {λ}_{3}^{- 2}\end{matrix} \vert = \frac{τ ( {λ}_{1} ) ( {λ}_{2}^{- 2} - {λ}_{3}^{- 2} ) + τ ( {λ}_{2} ) ( {λ}_{3}^{2} - {λ}_{1}^{- 2} ) + τ ( {λ}_{2} ) ( {λ}_{1}^{- 2} - {λ}_{2}^{- 2} )}{{λ}_{1}^{2} ( {λ}_{2}^{- 2} - {λ}_{3}^{- 2} ) + {λ}_{2}^{2} ( {λ}_{3}^{- 2} - {λ}_{1}^{- 2} ) + {λ}_{3}^{2} ( {λ}_{1}^{- 2} - {λ}_{2}^{- 2} )}$$

$$c = \vert \begin{matrix}1 & {λ}_{1}^{2} & τ ( {λ}_{1} ) \\ 1 & {λ}_{2}^{2} & τ ( {λ}_{2} ) \\ 1 & {λ}_{3}^{2} & τ ( {λ}_{3} )\end{matrix} \vert / \vert \begin{matrix}1 & {λ}_{1}^{2} & {λ}_{1}^{- 2} \\ 1 & {λ}_{2}^{2} & {λ}_{2}^{- 2} \\ 1 & {λ}_{3}^{2} & {λ}_{3}^{- 2}\end{matrix} \vert = \frac{τ ( {λ}_{1} ) ( {λ}_{2}^{2} - {λ}_{3}^{2} ) + τ ( {λ}_{2} ) ( {λ}_{3}^{2} - {λ}_{1}^{2} ) + τ ( {λ}_{2} ) ( {λ}_{1}^{3} - {λ}_{2}^{2} )}{{λ}_{1}^{2} ( {λ}_{2}^{- 2} - {λ}_{3}^{- 2} ) + {λ}_{2}^{2} ( {λ}_{3}^{- 2} - {λ}_{1}^{- 2} ) + {λ}_{3}^{2} ( {λ}_{1}^{- 2} - {λ}_{2}^{- 2} )}$$

A wavelength dispersion D(λ) is calculated by the following equation.

$$\begin{matrix}[ Math . 5 ] & \\ D ( λ ) = \frac{d τ ( λ )}{d λ} = 2 b λ - 2 c {λ}^{- 3} & ( 5 )\end{matrix}$$

Equation 5 shows that the wavelength dispersion D(λ) to any wavelength λ can be calculated, using the coefficients b and C.

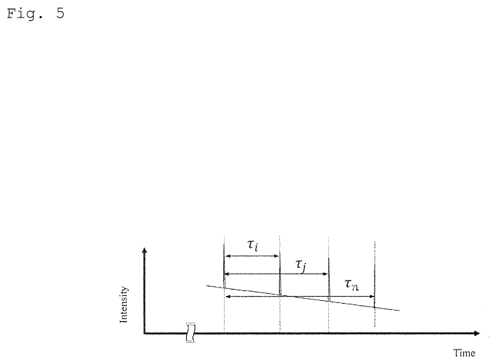

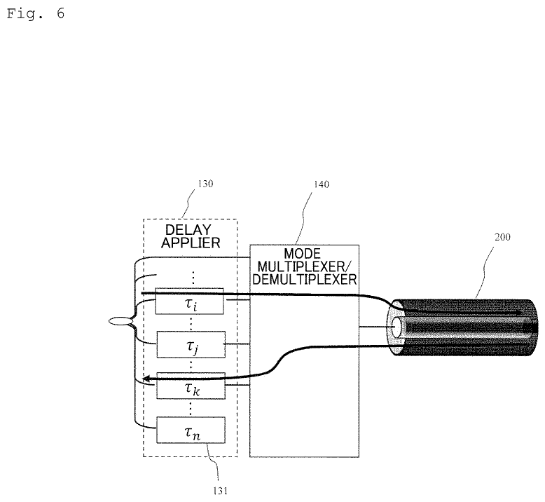

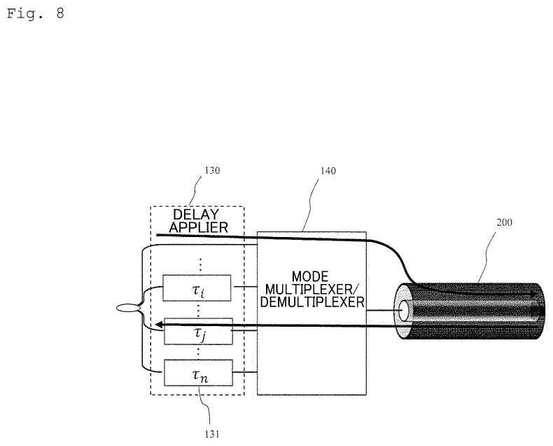

The delay amounts imparted by the delay applier 130 will be described. FIGS. 5, 7 and 9 are schematic diagrams of response waveforms of reflected optical pulses, and FIGS. 6 and 8 are models of propagation paths of optical pulses and reflected optical pulses. In FIGS. 5, 7 and 9, the reflected optical pulses are measured with regard to their respective delay amounts. In the models shown in FIGS. 6 and 8, each optical pulse passes through one of the delay units 131, passes through the mode multiplexer/demultiplexer 140, and is input to the test target optical fiber 200. Each reflected optical pulse reflected at the far end of the test target optical fiber 200 is output from the test target optical fiber 200, passes through one of the delay units 131 via the mode multiplexer/demultiplexer 140.

FIG. 5 premises that three reflected optical pulses are measured at time positions corresponding to delay amounts of τᵢ, τⱼ, and τₙ. Since individually imparting equal delay amounts results in reflected optical pulses having response waveforms close to each other, imparting different delay amounts to all propagation modes is desirable.

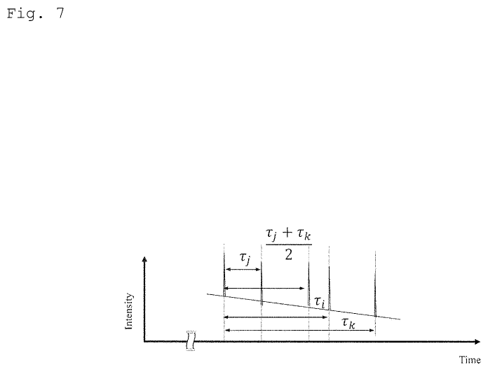

Further, as illustrated in FIG. 6, there is an assumption that a propagation mode to which a delay amount τⱼ is imparted is input to the test target optical fiber 200, and that the mode is converted into a propagation mode to which the delay amount τₖ is imparted, at a far end of the test target optical fiber 200. In this way, a component of a propagation mode, different from the original propagation mode that is converted thereinto, is detected, for example, as indicated by the middle peak among the five peaks of FIG. 7. This reflected optical pulse is detected (τⱼ+τₖ)/2 later in view of the reference reflected optical pulse. When the delay amount is equal to another delay amount τᵢ, the two reflected optical pulses approach to each other, and then the delay time cannot be measured accurately. That is, since any delay amount that is half of a sum of any two other delay amounts results in reflected optical pulses having response waveforms close to each other, any imparted delay amount that is not half of the sum of any two other delay amounts is desirable.

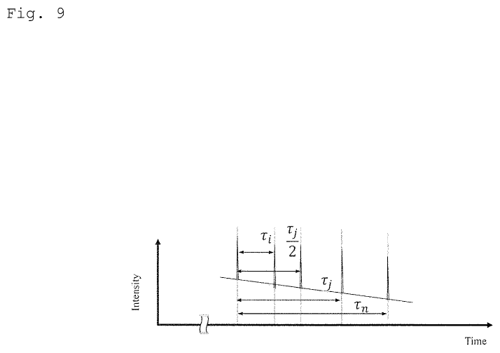

When, in the model illustrated in FIG. 6, a delay amount imparted to a propagation mode in one direction is zero, there is an example described below. For example, as illustrated in FIG. 8, there is an assumption that a propagation mode with a delay amount that is zero is input to the test target optical fiber 200, and the mode is converted into a propagation mode, with an imparted delay amount τⱼ, at a far end of the test target optical fiber 200. As shown in FIG. 9, since any delay amount that is half of any other delay amount also results in reflected optical pulses having response waveforms close to each other, any delay amount of the propagation modes that is not half of any other delay amount is desirable.

Further, for the sake of propagation modes that are measurable separately, each imparted delay amount is preferably larger than a maximum value of a group delay time difference between any propagation modes in the test target optical fiber 200.

The group delay time difference is in the order of several nanoseconds per 1 km of the optical fiber. That is, given that the length of the test target optical fiber is 10 km, the group delay time difference is about several tens of nanoseconds; desirably, the imparted delay amount is about several hundreds of nanoseconds. On the other hand, in the optical fiber as the delay unit, a delay amount generated per 1 m is about 5 ns; given that the length of the test target optical fiber is 10 km, the length of the optical fiber as the delay unit is, desirably, at least 100 m.

For example, when there are three delay units, satisfaction of all the above conditions regarding the delay amounts imparted by the delay applier 130 can be exemplified by, for example, a 100 m long optical fiber for one delay unit imparting a delay amount τ₁, a 600 m long optical fiber for another delay unit imparting a delay amount τ₂, and a 1 km long optical fiber for the other delay unit imparting a delay amount τ₃.

The invention of the present disclosure can be applied not only to an FMF as a test target optical fiber but also to a few mode multicore optical fiber.

As described above, the optical fiber group delay characteristic testing device and the optical fiber group delay characteristic testing method of the present disclosure enable efficient and economical measurement of the group delay characteristics of the multimode optical fiber.

### INDUSTRIAL APPLICABILITY

The present disclosure is applicable to information and communication industries.

### REFERENCE SIGNS LIST

100 Optical fiber group delay characteristic testing device
110 Optical pulse tester
111 Test optical pulse generator
112 Circulator
113 Optical receiver
120 Optical multiplexer/demultiplexer
130 Delay applier
131 Delay unit
140 Mode multiplexer/demultiplexer
150 Arithmetic processing unit
200 Test target optical fiber

1. An optical fiber group delay characteristic testing device comprising:
an optical pulse tester which outputs an optical pulse toward a test target optical fiber, and measures reflected optical pulses coming from the test target optical fiber;
an optical multiplexer/demultiplexer which demultiplexes the optical pulse from the optical pulse tester into a plurality of optical pulses, multiplexes the reflected optical pulses of a plurality of propagation modes coming from the test target optical fiber, and outputs the reflected optical pulses to the optical pulse tester;
a delay applier which imparts different delay amounts to a plurality of optical pulses from the optical multiplexer/demultiplexer separately, and imparts different delay amounts to reflected optical pulses of a plurality of propagation modes coming from the test target optical fiber;
a mode multiplexer/demultiplexer which multiplexes the plurality of optical pulses from the delay applier, inputs the plurality of optical pulses into the test target optical fiber so that the plurality of optical pulses have different propagation modes separately, demultiplexes the reflected optical pulses of the different propagation modes from the test target optical fiber, for each propagation mode, and outputs the reflected optical pulses to the delay applier separately; and
an arithmetic processing unit which measures a delay time for each propagation mode with regard to a period from a time when the optical pulses, originating from the optical pulse tester, are input to the test target optical fiber to a time when the reflected optical pulses are output from the test target optical fiber, and calculates group delay characteristics based on the measured delay time for each propagation mode.

2. The optical fiber group delay characteristic testing device according to claim 1, wherein the arithmetic processing unit corrects a delay time for each propagation mode, with regard to a period from a time when the optical pulse is output from the optical pulse tester to a time when the reflected optical pulses are measured thereby, by the delay amounts for the respective propagation modes imparted by the delay applier, and calculates a group delay for each propagation mode.

3. The optical fiber group delay characteristic testing device according to claim 2, wherein the arithmetic processing unit calculates a group delay time difference between propagation modes from the group delay of each of the propagation modes.

4. The optical fiber group delay characteristic testing device according to claim 2,
wherein the optical pulse tester outputs optical pulses, using three or more different wavelengths, toward the test target optical fiber, and measures reflected optical pulses from the test target optical fiber, and
the arithmetic processing unit calculates a group delay of each wavelength for each propagation mode, and calculates a wavelength dispersion for each propagation mode.

5. The optical fiber group delay characteristic testing device according to claim 1, wherein any delay amount imparted by the delay applier is not a half of a sum of any two other delay amounts.

6. The optical fiber group delay characteristic testing device according to claim 1, wherein any delay amount imparted by the delay applier is not half of any other delay amount.

7. An optical fiber group delay characteristic testing method comprising:
measuring a delay time for each propagation mode, with regard to a period from a time when a plurality of optical pulses are input into a test target optical fiber so that the plurality of optical pulses have different propagation modes to a time when reflected optical pulses of different propagation modes are output from the test target optical fiber, by imparting different delay amounts to propagation modes separately; and
correcting the measured delay time for each propagation mode by the delay amounts for the respective propagation modes, and calculating group delay characteristics for each propagation mode.

8. The optical fiber group delay characteristic testing method according to claim 7,
wherein any imparted delay amount is larger than a maximum value of a group delay time difference between any propagation modes in the test target optical fiber.
